(19) United States
(12) Patent Application Publication
(10) Pub. No.: US 2007/0277699 A1
(43) Pub. Date: Dec. 6, 2007

(54) Carbonyl self-dispersing pigment and inkjet ink comprising same

(76) Inventor: Richard Douglas Bauer, Kennett Square, PA (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/810,505

(22) Filed: Jun. 5, 2007

Related U.S. Application Data
(60) Provisional application No. 60/810,937, filed on Jun. 5, 2006.

(51) Int. Cl. C09D 11/02; C09C 1/44; C08K 5/00

(52) U.S. Cl. 106/31.6; 106/476; 106/493; 106/499; 106/31.75

(57) ABSTRACT

Pigments having covalently bound stabilizing groups that enable formation of a stable dispersion of the pigment in a liquid and covalently bound species containing at least one external reactive carbonyl group are disclosed Such pigments are particularly useful in reactive inkjet ink formulations.

### CROSS-REFERENCE TO RELATED APPLICATION

This application claims priority from U.S. Provisional Application Ser. No. 60/810,937 filed on Jun. 5, 2006, the disclosure of which is incorporated by reference herein for all purposes as if fully set forth.

### BACKGROUND OF THE INVENTION

The present invention relates generally to self-dispersing pigments and to use thereof in inkjet ink. More particularly, it is directed to a self-dispersing pigment having covalently bound stabilizing groups that enable formation of a stable dispersion of the pigment in a liquid and in addition, at least one covalently bound external reactive carbonyl group. This pigment is particularly useful in reactive inkjet ink formulations.

Inkjet printing is a non-impact printing process in which droplets of ink are deposited on various media to form the desired image. The droplets are ejected from a printhead in response to electrical signals generated by a microprocessor. Inks used are subject to rigorous demands including, for example, good dispersion stability, ejection stability, and good fixation to media.

Inkjet printers offer low cost, high quality printing and have become a popular alternative to other types of printers such as laser printers. However, inkjet printers have been unable to match the speed of laser printers and the durability of the laser printed images. Inkjet prints with increased durability would be highly advantageous.

Using a reactive inkjet ink set comprising at least two inks can increase the durability of inkjet prints. The first ink contains species having at least one reactive carbonyl group; and the second ink contains species having at least one reactive amine group.

The advantages of such reactive ink sets are fully described in the commonly owned U.S. Patent Application Ser. No. 60/780,706 (filed Mar. 9, 2006) and can be best realized when the two inks are printed onto a substrate in an overlapping relationship. In this way, both types of reactive species are in close proximity on the substrate and crosslinking can readily occur to thereby increase the durability of the print. Printing of the inks can occur in any order or simultaneously. It may be advantageous to heat the printed substrate to accelerate groups. Useful temperatures for this purpose are typically from about 60° C. to about 150° C.

There is still a need for new chemistries to broaden the choices of reactive species that are compatible, stable, and can be easily introduced into reactive ink sets in order to optimize performance. Accordingly, there is a need for reactive carbonyl group-containing self-dispersing pigments suitable for inkjet printing and it is an objective of this invention to provide such pigments.

### SUMMARY OF THE INVENTION

In one aspect, the present invention pertains to a self-dispersing pigment comprising pigment particles having (a) covalently bound stabilizing groups that enable formation of a stable dispersion of the pigment in a liquid and (b) covalently bound species containing at least one external reactive carbonyl group.

This invention further provides an inkjet ink comprising a liquid vehicle and pigment comprising pigment particles having covalently bound stabilizing groups that enable formation of a stable dispersion of the pigment in a liquid and covalently bound species containing at least one external reactive carbonyl group.

This invention also provides an inkjet ink set comprising at least a first ink and a second ink wherein,

a) the first ink comprises a liquid vehicle and pigment comprising pigment particles having covalently bound stabilizing groups that enable formation of a stable dispersion of the pigment in a liquid and covalently bound species containing at least one external reactive carbonyl group; and
b) the second ink comprises a liquid vehicle and species having at least one reactive amine group.

### BRIEF DESCRIPTION OF THE DRAWINGS

FIG. 1 shows, in schematic, examples of seven synthetic routes that can be used to produce carbonyl group containing self-dispersing carbon black or organic pigment particles, useful in the practice of this invention (with the resulting pigment particles being designated as particles 11-17, respectively).

FIG. 2 shows the preparation of the diazotized precursor used in the reaction producing carbonyl self-dispersing pigment particle 11 of FIG. 1.

FIG. 3 shows the preparation of the diazotized precursor used in the reaction producing carbonyl self-dispersing pigment particle 12 of FIG. 1 and alternative alkylation reagents to prepare analogs of carbonyl self-dispersing pigment particle 12.

FIG. 4 shows the preparation of the amine precursor used in the reaction producing carbonyl self-dispersing pigment particle 13 of FIG. 1.

FIG. 5 shows the preparation of the beta-keto amide precursors used in the producing carbonyl self-dispersing pigment particles 15 and 16 of FIG. 1.

FIG. 6 shows the preparation of the diketone precursor used in the reaction producing carbonyl self-dispersing pigment particle 17 of FIG. 1.

FIG. 7 illustrates three additional synthetic routes that can be used to form carbonyl self-dispersing carbon black or organic pigment particles, useful in the practice of this invention.

FIG. 8 shows examples of three other reactions that produce carbonyl self-dispersing carbon black or organic pigment particles, useful in the practice of this invention.

FIG. 9 shows examples of two further reactions that can be used to produce carbonyl self-dispersing carbon black or organic pigment particles useful in the practice of this invention by attaching carbonyl groups to the D groups.

FIG. 10 shows an example of another synthetic route to carbonyl self-dispersing carbon black or organic pigments, useful in the practice of this invention.

FIGS. 11-12 show examples of a synthetic route to produce carbonyl self-dispersing inorganic pigments, useful in the practice of this invention.

### DETAILED DESCRIPTION OF THE PREFERRED EMBODIMENTS

This invention provides a carbonyl self-dispersing pigment, i.e., a pigment with pigment particles containing covalently bound stabilizing groups that enable formation of a stable dispersion of the pigment in a liquid and covalently bound species containing at least one external reactive carbonyl group. A pigment particle contains a sufficient number of covalently bound stabilizing groups to enable the particles to form a stable dispersion in a liquid and contains at least one covalently bound external reactive carbonyl group. Preferably the pigment particle contains two or more external reactive carbonyl groups. The carbonyl self-dispersing pigment is particularly useful in an inkjet set ink when another ink in the ink set contains species having reactive amine groups.

The term “self-dispersing”, as generally understood in the art and as used herein, means a pigment having stabilizing groups covalently attached to the surface of the pigment particles such that the pigment particles form a stable dispersion in a liquid in the absence of any other dispersion agents. The covalently bound stabilizing groups that enable the formation of a stable dispersion of the pigment in a liquid are designated herein as “D” groups, i.e., dispersing groups.

In accordance with the present invention, novel self-dispersing pigments are also provided with reactive carbonyl group(s), so that they can participate in desired crosslinking reactions. In general, reactive carbonyl groups that are effective at crosslinking are not effective at dispersing and therefore the covalently bound dispersing group(s) and covalently bound reactive carbonyl group(s) on the instant self-dispersing pigment are typically separate and distinct species. Self-dispersing pigments with covalently bound dispersing groups are well known in the art, but self-dispersing pigments with both covalently bound dispersing groups and reactive carbonyl groups are novel and unique.

The carbonyl groups are “external” groups in the sense that a) they are not part of the pigment molecular formula but are attached substantially only to the pigment molecules at the surface of a pigment particle, and b) they are terminal groups at the outer end, i.e., the end not covalently bound to the pigment particle, of the entity that is covalently bound to the pigment particle. The carbonyl groups are described as “reactive” because they are capable of reacting with, i.e., crosslinking with, reactive amine groups. The reactivity of these carbonyl groups is increased as a result of their position at the outer end of the entity that is covalently bound to the pigment particle. Various alkyl or aryl groups or hydrogen can be attached to the carbonyl group to form ketones or aldehydes. Reactivity of the carbonyl group is expected to be highest when a methyl group or hydrogen is attached to the carbonyl group. The species containing the external reactive carbonyl groups can be covalently bound to the pigment particle or can be part of the covalently bound stabilizing groups. The species containing the external reactive carbonyl groups can be covalently bound directly to the pigment particle, attached to other groups that are covalently bound to the pigment particle, or appended to a polymer chain that is covalently bound to the pigment particle.

The pigment particles can be carbon black particles, organic colored pigment particles, or inorganic pigment particles. Representative commercial pigments in dry form include the following:

| | | Color Index (CI) |
|---|---|---|
| Trade Name | Manufacturer | Pigment Name |
| Permanent Yellow DHG | Hoechst | Yellow 12 |
| Permanent Yellow GR | Hoechst | Yellow 13 |
| Permanent Yellow G | Hoechst | Yellow 14 |
| Permanent Yellow NCG-71 | Hoechst | Yellow 16 |
| Permanent Yellow NCG-71 | Hoechst | Yellow 16 |
| Permanent Yellow GG | Hoechst | Yellow 17 |
| Hansa Yellow RA | Hoechst | Yellow 73 |
| Hansa Brilliant Yellow 5GX- | Hoechst | Yellow 74 |
| 02 | | |
| Dalamar ® Yellow YT-858-D | Heubach | Yellow 74 |
| Hansa Yellow X | Hoechst | Yellow 75 |
| Novoperm ® Yellow HR | Hoechst | Yellow 83 |
| Chromophtal ® Yellow 3G | Ciba-Geigy | Yellow 93 |
| Chromophtal ® Yellow GR | Ciba-Geigy | Yellow 95 |
| Novoperm ® Yellow FGL | Hoechst | Yellow 97 |
| Hansa Brilliant Yellow 10GX | Hoechst | Yellow 98 |
| Permanent Yellow G3R-01 | Hoechst | Yellow 114 |
| Chromophtal ® Yellow 8G | Ciba-Geigy | Yellow 128 |
| Irgazin ® Yellow 5GT | Ciba-Geigy | Yellow 129 |
| Hostaperm ® Yellow H4G | Hoechst | Yellow 151 |
| Hostaperm ® Yellow H3G | Hoechst | Yellow 154 |
| L74-1357 Yellow | Sun Chem | |
| L75-1331 Yellow. | Sun Chem | |
| L75-2377 Yellow | Sun Chem. | |
| Hostaperm ® Orange GR | Hoechst | Orange 43 |
| Paliogen ® Orange | BASF | Orange 51 |
| Irgalite ® Rubine 4BL | Ciba-Geigy | Red 57:1 |
| Quindo ® Magenta | Mobay | Red 122 |
| Indofast ® Brilliant Scarlet | Mobay | Red 123 |
| Hostaperm .RTM. Scarlet GO | Hoechst | Red 168 |
| Permanent Rubine F6B | Hoechst | Red 184 |
| Monastral ® Magenta | Ciba-Geigy | Red 202 |
| Heliogen .RTM. Blue L 6901F | BASF | Blue 15:2 |
| Heliogen ® Blue NBD 7010 | BASF | |
| Heliogen ® Blue K 7090 | BASF | Blue 15:3 |
| Heliogen ® Blue L 7101F | BASF | Blue 15:4 |
| Paliogen ® Blue L 6470 | BASF | Blue 60 |
| Heucophthal ® Blue G, XBT- | Heubach | Blue 15:3 |
| 583D | | |
| Heliogen ® Green K 8683 | BASF | Green 7 |
| Heliogen ® Green L 9140 | BASF | Green 36 |
| Monastral ® Violet R | Ciba-Geigy | Violet 19 |
| Monastral ® Red B | Ciba-Geigy | Violet 19 |
| Quindo ® Red R6700 | Mobay | |
| Quindo ® Red R6713 | Mobay | |
| Indofast ® Violet | Mobay | Violet 23 |
| Monastral ®. Violet Maroon B | Ciba-Geigy | Violet 42 |
| Special Black 4A | Degussa | Black 7 |
| Sterling ® NS 76 Black | Cabot | Black 7 |
| Sterling ® NSX 76 | Cabot | Black 7 |
| Mogul L | Cabot | Black 7 |

Representative commercial pigments available in the form of a water-wet presscake include: Heucophthal® Blue BT-585-P, Toluidine Red Y (C.I. Pigment Red 3), Quindo® Magenta (Pigment Red 122), Magenta RV-6831 presscake (Mobay Chemical, Harmon Division, Haledon, N.J.), Sunfast.®. Magenta 122 (Sun Chemical Corp., Cincinnati, Ohio), Indog Brilliant Scarlet (Pigment Red 123, C.I. No. 71145), Toluidine Red B (C.I. Pigment Red 3), Watchung® Red B (C.I. Pigment Red 48), Permanent Rubine F6B13-1731 (Pigment Red 184), Hansa® Yellow (Pigment Yellow 98), Dalamarg Yellow YT-839-P (Pigment Yellow 74, C.I. No. 11741, Sunbrite.® Yellow 17 (Sun Chemical Corp, Cincinnati, Ohio), Toluidine Yellow G (C.I. Pigment Yellow 1), Pigment Scarlet (C.I. Pigment Red 60), Auric Brown (C.I. Pigment Brown 6), etc. Black pigments, such as carbon black, generally are not available in the form of aqueous presscakes.

The liquid vehicle carrier of inkjet ink can be aqueous or organic.

The term “aqueous liquid” or “aqueous vehicle” refers to water or a mixture of water and at least one water-soluble organic solvent (co-solvent). Selection of a suitable mixture depends on requirements of the specific application, such as desired surface tension and viscosity, the selected colorant, drying time of the ink, and the type of substrate onto which the ink will be printed. If a mixture of water and a water-soluble solvent is used, the aqueous vehicle typically will contain about 30% to about 95% water with the balance (i.e., about 70% to about 5%) being the water-soluble solvent. Preferred compositions contain about 60% to about 95% water, based on the total weight of the aqueous vehicle.

“Organic liquid” or “organic vehicle” refers to a liquid or vehicle that is substantially nonaqueous and is comprised of organic solvent or mixtures of such solvents. These solvents can be polar and/or nonpolar. Examples of polar solvents include alcohols, esters, ketones and ethers, particularly mono- and di-alkyl ethers of glycols and polyglycols such as monomethyl ethers of mono-, di- and tri-propylene glycols and the mono-n-butyl ethers of ethylene, diethylene and triethylene glycols. Examples of nonpolar solvents include aliphatic and aromatic hydrocarbons having at least six carton atoms and mixtures thereof including refinery distillation products and by-products. Even when no water is deliberately added to the organic vehicle, some adventitious water may be carried into the formulation, but generally this will be no more than about 2-4%. As used herein, an organic vehicle will have no more than about 10%, and preferably no more than about 5%, by weight of water based on the total weight of the nonaqueous vehicle.

Numerous ways of functionalizing pigments with covalently bound stabilizing groups that will stabilize the particles, i.e., make them self-dispersing, in aqueous or organic vehicles have been disclosed. The covalently bound stabilizing groups for aqueous liquids can be carboxylate, amine, sulfonate, sulfinate, phosphate, amine, quaternized amine, or ethoxylate oligomer groups, or covalently bound polymers containing these stabilizing groups.

These covalently bound groups need to be present in sufficient quantity to allow the pigment particles to form a stabile dispersion as prepared or by neutralizing acidic groups with base to form anions or neutralizing basic groups with acid to form cations.

Inorganic oxide particles can be stabilized to form dispersions by adsorbed cations or anions or by covalently bound anionic or cationic groups for aqueous liquids or they can be stabilized to be dispersible in organic liquid. As used herein, covalently bound stabilizing groups includes these adsorbed cations or anions as well as the covalently bound anionic or cationic groups.

For organic liquids, covalently bound stabilizing groups compatible with organic liquids are used. The stabilizing groups in organic liquid can also be organic solvent compatible salts of bonded acid or basic groups.

Self-dispersing carbon black particle dispersions stabilized by carboxylate groups created by oxidation of the surface of those particles are disclosed in a number of patents. Self-dispersing carbon black prepared by ozonation and grinding of carbon black in a media mill is disclosed in U.S. Pat. No. 6,852,156. Processes to prepare a carbon black dispersion by treatment of carbon black with ultrasonic energy and hydrogen peroxide or with heat and a monopersulfate are disclosed in U.S. Pat. No. 6,723,161 and US 2004/0103822. A series of patents, U.S. Pat. No. 5,718,746, U.S. Pat. No. 5,846,307, U.S. Pat. No. 5,861,447, U.S. Pat. No. 6,468,342 and U.S. Pat. No. 6,480,753, disclose the preparation of stable dispersions using hypohalite reagents to oxidize carbon black.

U.S. Pat. No. 6,831,194 discloses the surface modification of carbon particles by reacting them with cyclic anhydrides and AlCl₃ catalyst and the formation of a stable aqueous dispersion.

U.S. Pat. No. 6,660,075 discloses the surface modification of carbon particles with reagents containing double and triple bonds activated by carbonyl groups, e.g., maleic anhydride. A variety of groups that can stabilize the particles in aqueous environments (anionic and cationic groups) or organic environments can be covalently bound to the particles using this chemistry.

U.S. Pat. No. 6,758,891 discloses the reaction of carbon particles with organic compounds of the general formula to functionalize them with carboxylates, sulfonates, amines, or quaternary groups for dispersion stability in aqueous environments or organic groups which will stabilize a dispersion of the particles in an organic environment.

US 2004/0138342 describes carbon particles reacted with compounds of the general formula R¹—N═N—R², wherein the R's are aryl groups that are unsubstituted or substituted with acceptor or donor substituents, that can be made into stable aqueous dispersions.

US2001/0036994 describes carbon black particles modified with organic groups which are bound via a sulfide or polysulfide linkage by reacting those particles with compounds of the general formula R¹—Sₓ—R².

U.S. Pat. No. 5,922,118, U.S. Pat. No. 5,900,029, U.S. Pat. No. 5,851,280, U.S. Pat. No. 5,895,522, U.S. Pat. No. 5,885,335, U.S. Pat. No. 5,851,280; and U.S. Pat. No. 5,837,045 disclose methods for attaching organic stabilizing groups to carbon black via a diazonium reaction wherein the organic stabilizing group is part of the diazonium salt. The stabilizing groups include carboxylates, sulfonates, amines, and quaternary amines that would stabilize a dispersion of the particles in an aqueous medium and organic groups that would stabilize the particles in an organic medium. U.S. Pat. No. 6,398,858, U.S. Pat. No. 6,494,943, and U.S. Pat. No. 6,506,245 describe similar methods for attaching stabilizing groups to colored organic pigments. U.S. Pat. No. 5,713,988, U.S. Pat. No. 6,336,965, and U.S. Pat. No. 6,432,194 describe carbon blacks functionalized with diazonium salts containing non-ionic stabilizing groups (and optionally ionic groups) for stabilizing the pigments in organic or aqueous vehicles.

Carbon black particles can be modified by the addition of radicals containing groups that will stabilize a dispersion of the particles in aqueous or organic vehicles. Such dispersions can be suitable for inkjet. JP 11323176A describes carbon black particles functionalized with azonitrile compounds of the general formula (X)(Y)(CN)C—N═N—C(CN)(Y)(X), where X and Y are substituents which can contain hydrophobic or hydrophilic groups. An example of a preferred radical forming reagent with hydrophilic groups is 4,4′-Azobis(4-cyanopentanecarboxylic acid).

JP 11323178A discloses carbon particles functionalized with hyponitrite esters of the general formula A₁-O—N═N—O-A₂, where A₁ and A₂ are the same or different substituted linear, branched, or cyclic hydrocarbons groups that can contain hydrophilic or hydrophobic groups.

JP 11323229A describes carbon particles functionalized with azo compounds of the general formula A₁-N═N-A₂, where A₁ and A₂ are the same or different substituted linear, branched, or cyclic hydrocarbons groups that can contain hydrophilic or hydrophobic groups. Azo radical forming compounds that would impart aqueous dispersability would include:

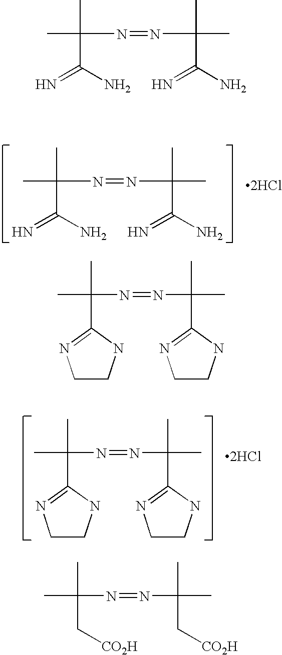

JP 11323179A describes carbon particles functionalized with peroxydicarbonate compounds of the general formula A₁-O(O═)C—O—O—C(═O)O-A₂, where A₁ and A₂ are the same or different substituted linear, branched, or cyclic hydrocarbons groups that can contain hydrophilic or hydrophobic groups.

JP 11323222A discloses carbon particles functionalized with hydroperoxide compounds of the general formula A₁-O—O—H, where A₁ is a substituted linear, branched, or cyclic hydrocarbons group that can contain hydrophilic or hydrophobic groups.

JP 11335586A describes carbon particles functionalized with peroxyester compounds of the general formula A₁(O═)C—O—O-A₂, where A₁ and A₂ are the same or different substituted linear, branched, or cyclic hydrocarbons groups that can contain hydrophilic or hydrophobic groups.

JP 11335587A describes carbon particles functionalized with peroxyester compounds of the general formula A₁-O—O-A₂, where A₁ and A₂ are different substituted linear, branched, or cyclic hydrocarbons groups that can contain hydrophilic or hydrophobic groups.

JP 11335587A describes carbon particles functionalized with diacyl peroxides of the general formula A₁-C(═O)—O—O—C(═O)-A₂, where A₁ and A₂ are different substituted linear, branched, or cyclic hydrocarbons groups which can contain hydrophilic or hydrophobic groups.

The stabilization of carbon black by surface grafting of polymers has been extensively reviewed by Tsubokawa, Prog. Polym. Sci, Vol. 17, 417-470 (1992) and Bull. Chem. Soc Jpn., 75, 2115-2136 (2002). Of the three primary ways of grafting, termination of a growing polymer chain onto the carbon black surface provided the lowest percentage of grafted chains. Grafting by means of initiating groups bound to the surface of the carbon black particle and reacting preformed polymers and oligomers containing functional groups with functional groups already bound to the carbon surface provide good results.

The preparation of self dispersing pigments for use in inkjet applications incorporating covalently attached polymers is described in U.S. Pat. No. 6,150,433 and U.S. Pat. No. 6,323,257. The preparation starts with a pigment modified for water dispersibility to which is attached groups with vinyl unsaturation. A wide range of monomers is disclosed for grafting to these unsaturated sites to form polymer chains.

Carbonyl self-dispersing organic and carbon black pigments can be prepared in a variety of ways. Species containing at least one external reactive carbonyl group can be covalently bonded to self-dispersing pigment particles suitable for inkjet ink use. The addition of the stabilizing groups prior to covalently bonding the species containing at least one external reactive carbonyl group can be advantageous in that the proper pigment particle size can be achieved and assured before the addition of the carbonyl groups. Alternatively, the stabilizing groups and the species containing at least one external reactive carbonyl group can be covalently bonded to the pigment particles in a single process.

The species containing at least one external reactive carbonyl group can be a ketone, beta diketone, beta keto ester group, their imine and enamine forms and their aldehyde analogs. The imine and enamine forms can be in equilibrium with the carbonyl when amines are present in solution with the carbonyl. The various species are depicted as follows.
—C(═O)R wherein R is a C₁ to C₁₀ alkyl group or an aryl group for the ketone and R is H for aldehyde.
—C(═NR¹)R wherein R is a C₁ to C₁₀ alkyl group or an aryl group for the imine and R is H for the aldehyde analog and wherein R¹ is a C₁ to C₁₀ alkyl group or an aryl group.
—C═C(NR¹R²)R wherein R is a C₁ to C₁₀ alkyl group or an aryl group for the enamine and R is H for the aldehyde analog and wherein R¹ and R² are the same or different C₁ to C₁₀ alkyl groups or an aryl groups.
—X—C(═O)—C(R¹)H—C(═O)—R wherein X is CH₂ for the beta diketone and X is O or NH for the beta keto ester, wherein R¹ is a C₁ to C₁₀ alkyl group or an aryl group and wherein R is a C₁ to C₁₀ alkyl group or an aryl group for the ketones and R is H for the aldehyde analogs.
—X—C(═O)—C(R¹)H—C(═NR¹)—R wherein X is CH₂, O or NH, wherein R¹ is a C₁ to C₁₀ alkyl group or an aryl group and wherein R is a C₁ to C₁₀ alkyl group or an aryl group for the imine form analogs of the above diketone and ester and R is H for the aldehyde analogs.
—X—C(═O)—C(R¹)H═C(NR¹R²)—R wherein X is CH₂, O or NH, R¹ and R² are the same or different C₁ to C₁₀ alkyl groups or an aryl groups and wherein R is a C₁ to C₁₀ alkyl group or an aryl group for the enamine form analogs of the above diketone and ester and R is H for the aldehyde analogs.

The species containing at least one external reactive carbonyl group also includes ketone and aldehyde groups activated by an electron withdrawing group (EWD). The EWD can be a CN group, a SO group, a SO₂ group, a SO₃ group, a SO₂NH group, a PO group, a PO₃ group, or a PO₂NH group. The point of attachment of these species to the pigment particle or to an entity covalently bonded to the pigment particle species can be either through the alpha carbon between the reactive carbonyl and the EWD or through the EWD, valency permitting. The various species are depicted as follows:

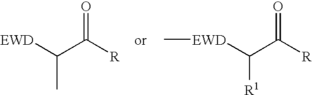

wherein EWD is a CN, SO, SO₂, SO₃, SO₂NH, PO, PO₃ or PO₂NH group, wherein R¹ is a C₁ to C₁₀ alkyl group or an aryl group and wherein R is a C₁ to C₁₀ alkyl group or an aryl group for the activated ketone and R is H for the activated aldehyde.

The species can also be a ketal, acetal, cyclic ketal, or cyclic acetal group. The ketals and acetals are stable in neutral or slightly alkaline solution but revert to the reactive ketone or aldehyde in the presence of acid. The various species are depicted as follows:
—C(—OR¹)₂R wherein R¹ is a C₁ to C₁₀ alkyl group or an aryl group and wherein R is a C₁ to C₁₀ alkyl group or an aryl group for the ketal and R is H for the acetal.

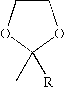

wherein R is a C₁ to C₁₀ alkyl group or an aryl group for the cyclic ketal and R is H for the cyclic acetal.

In all of the species above, it is preferred that R be a methyl group or H.

In summary, the species containing at least one external reactive carbonyl group is selected from the group consisting of ketone, aldehyde, beta diketone, beta keto ester, imine and enamine forms of ketone, aldehyde, beta diketone, and beta keto ester, ketal, acetal, cyclic ketal, cyclic acetal, ketone activated with an electron withdrawing group, aldehyde activated with an electron withdrawing group, and combinations thereof. As used herein, ketone or aldehyde groups include all of these groups.

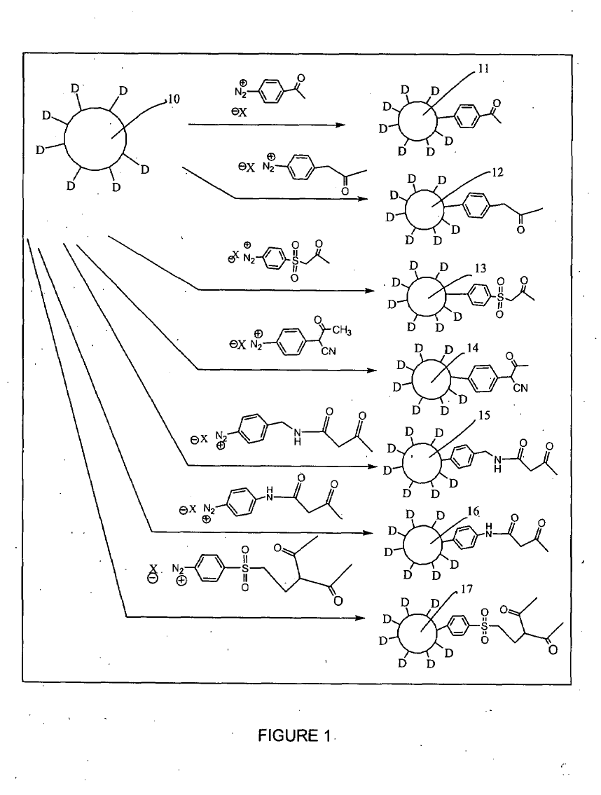

Referring now to the drawings, illustrated in FIG. 1 are seven examples of reactions of a carbon black pigment or organic pigment particle, identified by reference numeral 10, with diazotized reagents that produce the desired carbonyl self-dispersing carbon black pigment or organic pigment particles, which are identified by reference numerals 11-17. The carbon black or organic pigment particle 10 as shown has been surface functionalized to contain D groups to enable the formation of stable dispersions in an aqueous vehicle. The dispersing D groups can be introduced by any of the methods described above that would be appropriate for a given pigment. The covalent attachment of reactive ketone or aldehyde groups to the pigment particle surface is carried out with the diazotized reagents.

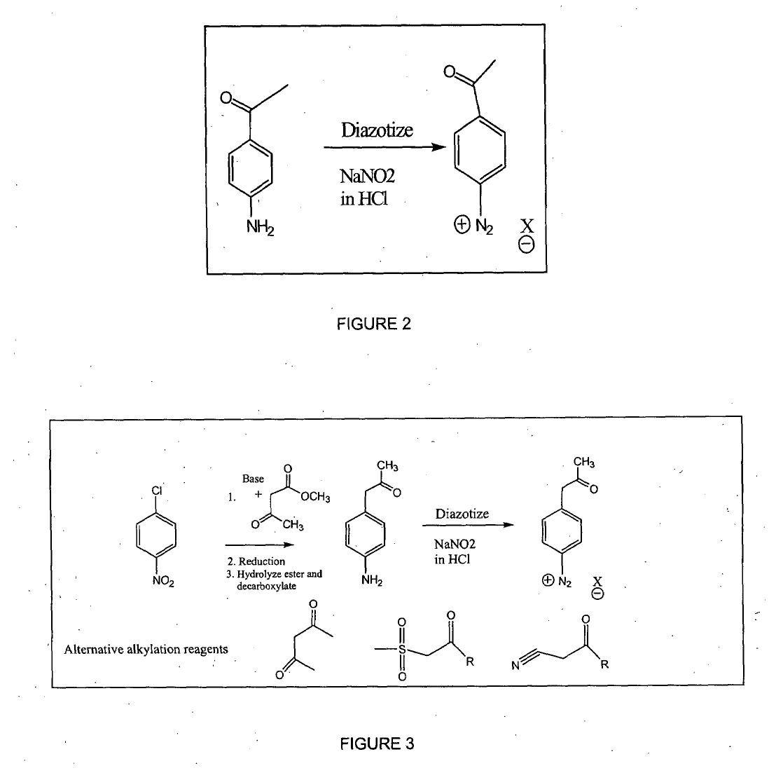

The diazotized precursor used in the reaction producing carbonyl self-dispersing pigment particle 11 would be prepared as shown in FIG. 2 using para-aminoacetophenone, a commercially available compound which can be diazotized with sodium nitrite in aqueous HCl. The diazotized precursor is then reacted with dispersed pigment particles as shown in FIG. 1 to provide the desired carbonyl self-dispersing pigment particles.

The amino ketones used to prepare the diazotized precursors used in the reaction producing carbonyl self-dispersing pigment particles 12 or 14 can be made using a synthetic strategy analogous with that described by Howell and Liu, Thermochimica Acta, 243, (1994), 169-192 as shown in FIG. 3 for pigment particle 12. The chloro group on p-chloro nitrobenzene is displaced with the methylacetoacetate anion, followed by reduction of the nitro group and hydrolysis and decarboxylation to yield the amine which can be diazotized with sodium nitrite in aqueous HCl. The diazotized precursor is then reacted with dispersed pigment particles as shown in FIG. 1 to provide the desired carbonyl self-dispersing pigment particles with reactive aliphatic ketone groups. Analogs of this ketone, e.g., the one used in the reaction producing the desired carbonyl self-dispersing Pigment particle 14 as shown in FIG. 1, can be prepared by using alternative alkylating agents such as those shown in FIG. 3.

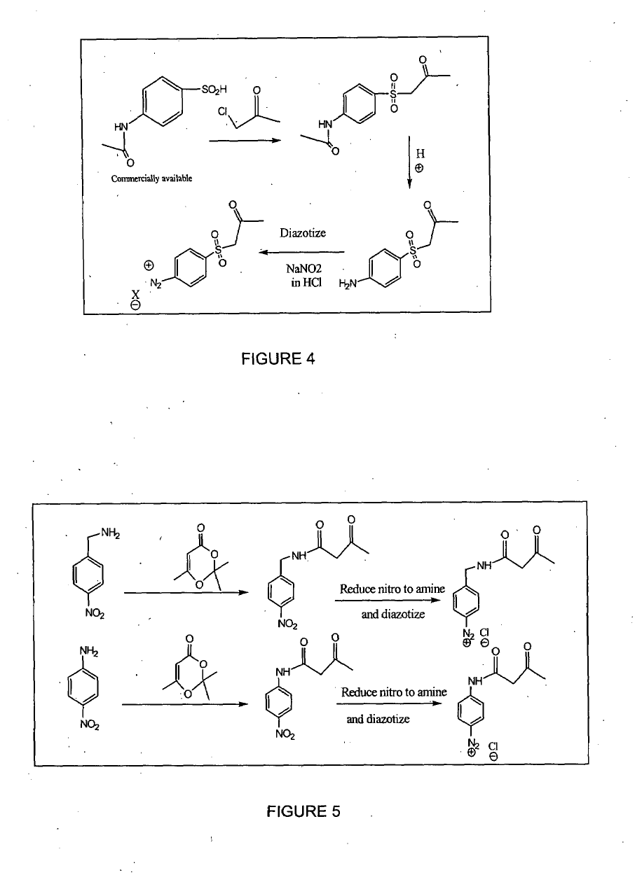

The amine precursor used in the reaction producing carbonyl self-dispersing pigment particle 13 can be prepared by a synthetic route analogous to one described by Wang, et. al., Dyes and Pigments, 41 (1999), 35-39 as shown in FIG. 4. The sodium salt of the commercially available sulfinic acid can be reacted with chloro acetone, followed by cleavage of the acetyl group form the amine and then diazotization. The amine precursor is then reacted with dispersed pigment particles as shown in FIG. 1 to provide the desired carbonyl self-dispersing pigment particles.

The beta-keto amide precursors used in the reactions producing carbonyl self-dispersing pigment particles 15 and 16 can be prepared by reacting p-nitrobenzyl amine in the case of 15 or p-nitroaniline in the case of 16 with diketene or with 2,2,6-trimethyl-4H-1,3-dioxin-4-one as shown in FIG. 5. The nitro groups are then reduced to amines as shown and each is diazotized with sodium nitrite in aqueous HCl. The beta-keto amide precursors are reacted with dispersed pigment particles as shown in FIG. 1 to provide the desired carbonyl self-dispersed pigment particles with reactive beta-ketone groups.

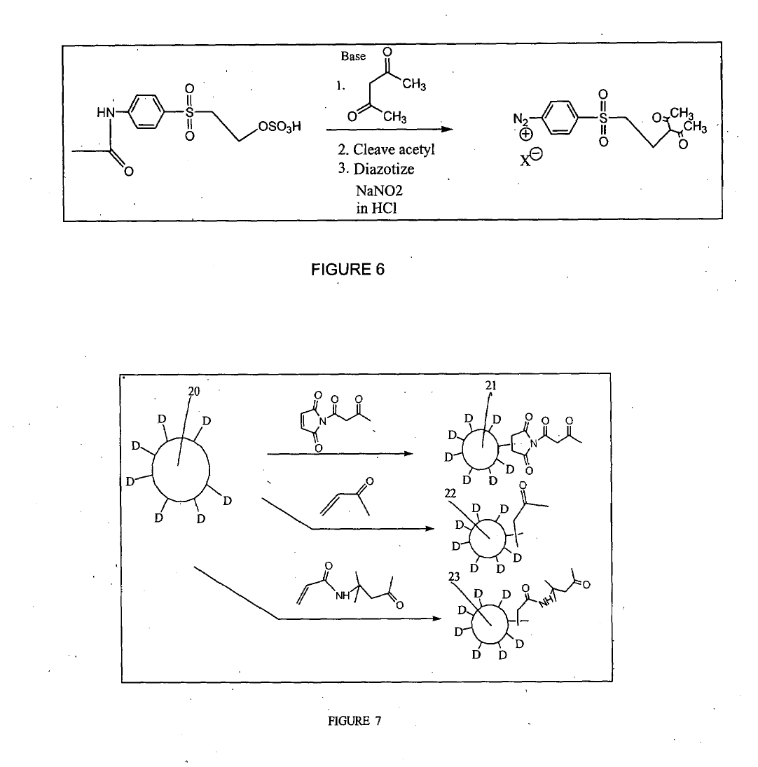

The diketone precursor used in the reaction producing carbonyl self-dispersing Pigment particle 17 can be prepared as shown in FIG. 6 by starting with the sulfate ester of a blocked vinyl sulfone that is reacted with acetyl acetone anion. This is followed by cleaving the acetyl group protecting the amine. The resulting amine can be diazotized with sodium nitrite in aqueous HCl. The diketone precursor is then reacted with dispersed pigment particles to provide the desired carbonyl self-dispersing pigment particles with reactive beta-diketone groups.

Three examples of another route for producing self-dispersing carbon black or organic pigment particles with reactive carbonyl groups are illustrated in FIG. 7. The carbon black pigment or organic pigment particle 20 has been surface functionalized to contain D groups to enable the formation of stable dispersions in an aqueous vehicle. Again, the dispersing D groups can be introduced by any of the methods described above that would be appropriate for a given pigment. Reagents containing carbonyl groups and activated double bonds would be reacted with the pigment particle 20 to produce carbonyl self-dispersing pigment particles 21, 22 and 23. The ketone precursor to particle 22 can be prepared by reaction between diketene and phthalimide. The ketone reagent precursors for particles 22 and 23 are commercially available.

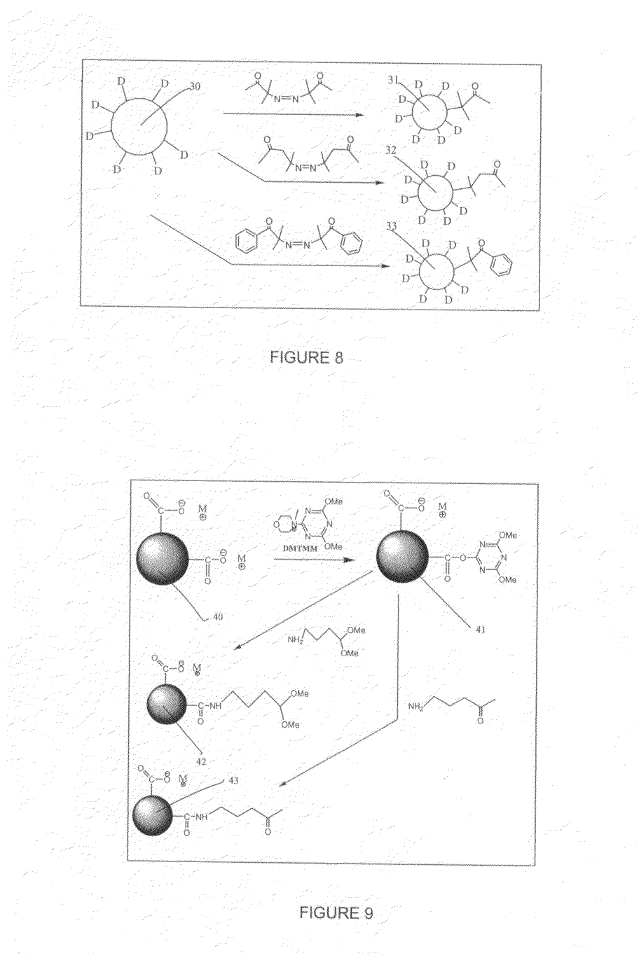

Three examples of still another route for producing self-dispersing carbon black or organic pigment particles with reactive carbonyl groups are illustrated in FIG. 8. The carbon black or organic pigment particle 30 has been surface functionalized to contain D groups. Reagents that are capable of fragmenting into radicals and contain reactive carbonyl groups would be reacted with the pigment particle 30 to produce carbonyl self-dispersing pigment particles 31, 32 and 33. The preparation of the azo ketone precursors for 31, 32, and 33 is described in Tetrahedron, Vol 36, 1753 (1980) and Tetrahedron Letters, Vol 28, pp 4255-4258, 1987.

Carbonyl self-dispersing pigments can be prepared by the appropriate reactions on the stabilizing groups or other groups that have already been attached to the pigment surface. Tsubokawa, Reactive and Functional Polymers, 27, 75-81 (1995), disclosed attaching polymers and oligomers with terminal amine or hydroxyl groups to carbon blacks functionalized with acyl azides, anhydrides, acyl imidazoles, p-nitrophenyl esters, and pentachlorophenyl esters—all derived from carboxyl groups appended to particle surface. Reagents which contain both amines and reactive carbonyls, or carbonyls as acetals or ketals, can be appended to carboxylated carbon blacks and other organic pigments in the same fashion to form carbonyl self-dispersing pigments.

M. Kunishima, Tetrahedron, 57, 1551-1558 (2002), describes the use of 4-(4,6-dimethoxy-1,3,5-triazin-2-yl)-4-methylmorpholinium chloride (DMTMM) to prepare amides of carboxylic acids or their carboxylates in yields of 70% or more in aqueous solutions. The reaction to form the activated ester can be done in the presence of the amine. This chemistry would be well suited for appending reagents containing ketones or aldehydes with amine groups to the D groups of carboxylated pigments directly in the aqueous phase as illustrated in FIG. 9. The carboxylated dispersed pigment particle 40 is reacted with DMTMM to form the activated ester 41. As shown, a reagent containing aldehyde or ketone is then reacted with the activated ester to produce carbonyl self-dispersing pigment particles 42 and 43.

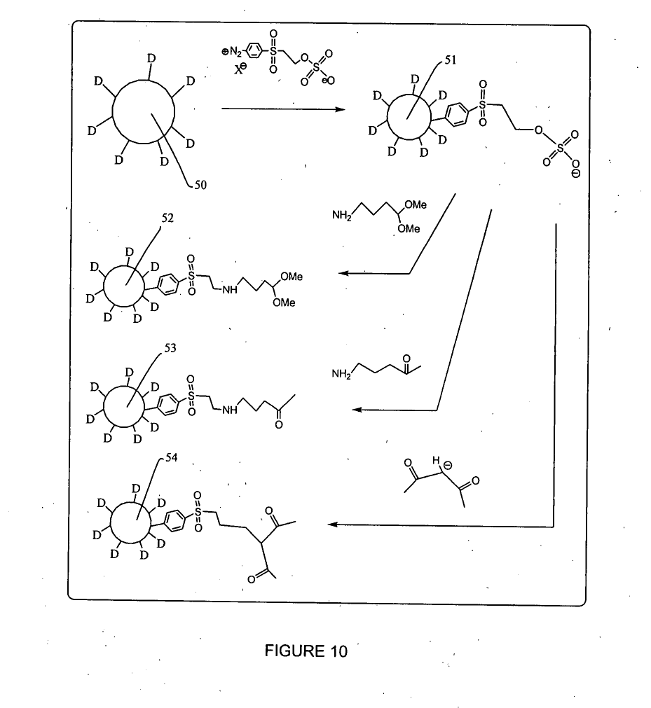

U.S. Pat. No. 6,723,783 discloses carbon particles that have been reacted with diazotized 2-(4-aminophenylsulfonyl)ethyl hydrogen sulfate to yield self-dispersing carbon black pigment or organic pigment particles that can be further reacted with amine containing reagents while in the aqueous phase. These pigment particles are reacted with polyamine species to prepare polymer modified particles. For the purposes of the instant invention, these pigment particles can be reacted with amine or other nucleophilic reagents containing carbonyls to form carbonyl self-dispersing carbon black pigments or organic pigments. As illustrated in FIG. 10, the carbon black pigment or organic pigment particle 50 can have separate dispersing groups, e.g., carboxyls, so that they would remain self-dispersing after all of the sulfate groups had been displaced and such D groups are shown in FIG. 10. The reaction with diazotized 2-(4-aminophenylsulfonyl)ethyl hydrogen sulfate yields the self-dispersing pigment particle 51. The precursor nucleophiles are commercially available materials. Their reaction with pigment particle 51 yields carbonyl self-dispersing carbon black pigment or organic pigment particle 52, 53, and 54.

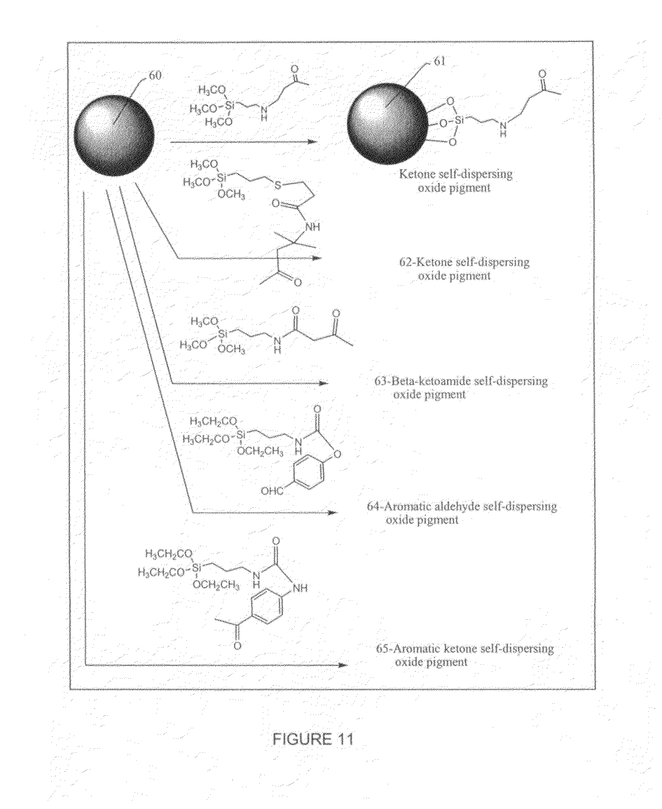

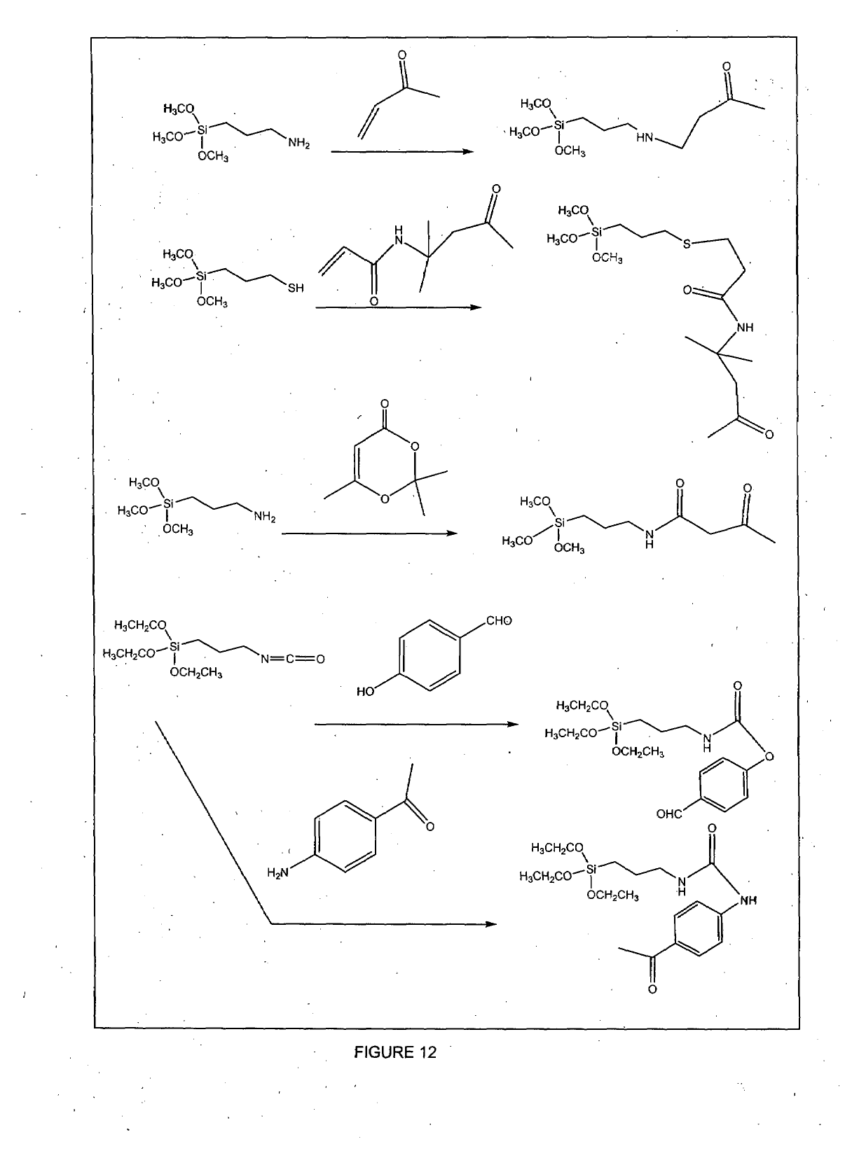

Carbonyl self-dispersing inorganic pigments are another embodiment of the instant invention. Oxide pigments are preferred, e.g., TiO2 or iron oxide. The pigments may also bear one or more metal oxide surface coatings. These coatings may be applied using techniques known by those skilled in the art. Examples of metal oxide coatings include silica, alumina, alumina-silica and zirconia. The surfaces of these oxide particles contain hydroxyl groups that allow them to be functionalized with siloxane reagents containing reactive ketone groups. Examples of five reactions of different siloxane reagents with an oxide pigment particle that produce carbonyl self-dispersing oxide pigment are illustrated in FIG. 11. The oxide particle 60 is reacted with the respective siloxane to produce carbonyl self-dispersing oxide pigments 61-65. FIG. 12 illustrates synthetic routes to the five siloxane reagents used in the reactions shown in FIG. 11.

What is claimed is:

1. A self-dispersing pigment comprising pigment particles having one or more covalently bound stabilizing groups that enable formation of a stable dispersion of the pigment in a liquid and one or more covalently bound species containing at least one external reactive carbonyl group.

2. The pigment of claim 1, wherein the covalently bound species containing the at least one external reactive carbonyl group is selected from the group consisting of C₁ through C₁₀ and a combination thereof, wherein
(C₁) is —C(═O)R
(C₂) is —C(═NR¹)R
(C₃) is —C═C(NR¹R²)R
(C₄) is —X—C(═O)C(R¹)H—C(═O)—R
(C₅) is —X—C(═O)—C(R¹)H—C(═NR¹)—R
(C₆) is —X—C(═O)—C(R¹)H═C(NR¹R²)—R
(C₇) is —C(—OR¹)₂R 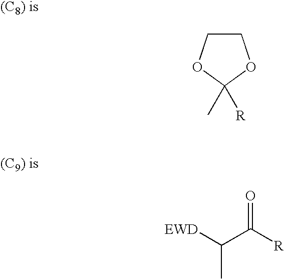
(C₁₀) is
and wherein
R is a C₁ to C₁₀ alkyl or aryl group or H:
R¹ is a C₁ to C₁₀ alkyl or aryl group;
R² is a C₁ to C₁₀ alkyl or aryl group; 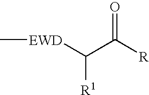
X is CH₂, O or NH; and
EWD is a CN, SO, SO₂, SO₃, SO₂NH, PO, PO₃ or PO₂NH group.

3. The pigment of claim 2, wherein R is a methyl group or H.

4. The pigment of claim 2, wherein the covalently bound stabilizing groups are selected from carboxylate, amine, sulfonate, sulfinate, phosphate, amine, quaternized amine, or ethoxylate oligomer groups that enable the pigment to form a stable dispersion in an aqueous liquid.

5. The pigment of claim 2 wherein the pigment particles are selected from the group consisting of organic colored pigment particles, or inorganic pigment particles.

6. The pigment of claim 2 wherein the pigment particles are carbon black that have been oxidized to form carboxylate stabilizing groups on the surface, and which also contain covalently bound species containing at least one external reactive carbonyl group.

7. An inkjet ink comprising a liquid vehicle and a self-dispersing pigment comprising pigment particles having covalently bound stabilizing groups that enable the pigment to form a stable dispersion in the liquid vehicle and covalently bound species containing at least one external reactive carbonyl group.

8. The inkjet ink of claim 7, wherein the covalently bound species containing the at least one external reactive carbonyl group is selected from the group consisting of any one of C₁ through C₁₀ and a combination thereof, wherein
(C₁) is —C(═O)R
(C₂) is —C(═NR¹)R
(C₃) is —C═C(NR¹R²)R
(C₄) is —X—C(═O)—C(R¹)H—C(═O)—R
(C₅) is —X—C(═O)—C(R¹)H—C(═NR¹)—R
(C₆) is —X—C(═O)—C(R¹)H═C(NR¹R²)—R
(C₇) is —C(—OR¹)₂R 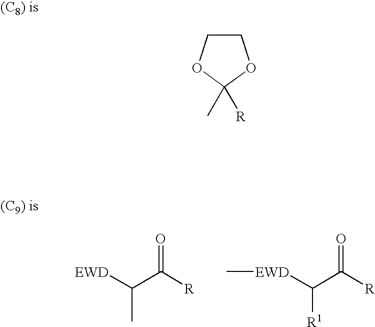
(C₁₀) is
and wherein
R is a C₁ to C₁₀ alkyl or aryl group or H:
R¹ is a C₁ to C₁₀ alkyl or aryl group;
R² is a C₁ to C₁₀ alkyl or aryl group;
X is CH₂, O or NH; and
EWD is a CN, SO, SO₂, SO₃, SO₂NH, PO, PO₃ or PO₂NH group.

9. The inkjet ink of claim 8, wherein R is a methyl group or H.

10. The inkjet ink of claim 8, wherein the liquid vehicle is an aqueous vehicle and the covalently bound stabilizing groups are selected from carboxylate, amine, sulfonate, sulfinate, phosphate, amine, quaternized amine, or ethoxylate oligomer groups that enable the pigment to form a stable dispersion in an aqueous vehicle.

11. The inkjet ink of claim 8 wherein the pigment particles are selected from the group consisting of organic colored pigment particles, or inorganic pigment particles.

12. The inkjet ink of claim 8 wherein the pigment particles are carbon black that have been oxidized to form carboxylate stabilizing groups on the surface, and which also contain covalently bound species containing at least one external reactive carbonyl group.

13. An inkjet ink set comprising at least a first ink and a second ink wherein,
a) the first ink comprises a liquid vehicle and a self-dispersing pigment comprising pigment particles having covalently bound stabilizing groups that enable the pigment to form a stable dispersion in the liquid vehicle and at least one covalently bound species containing at least one external reactive carbonyl group; and
b) the second ink comprises a liquid vehicle and species having at least one reactive amine group.

14. The inkjet ink set of claim 13, wherein the covalently bound species containing the at least one external reactive carbonyl group is selected from the group consisting of any one of C₁ through C₈ and a combination thereof, wherein
(C₁) is —C(═O)R
(C₂) is —C(═NR¹)R
(C₃) is —C═C(NR¹R²)R
(C₄) is —X—C(═O)—C(R¹)H—C(═O)—R
(C₅) is —X—C(═O)—C(R¹)H—C(═NR¹)—R
(C₆) is —X—C(═O)—C(R¹)H═C(NR¹R²)—R
(C₇) is —C(—OR¹)₂R 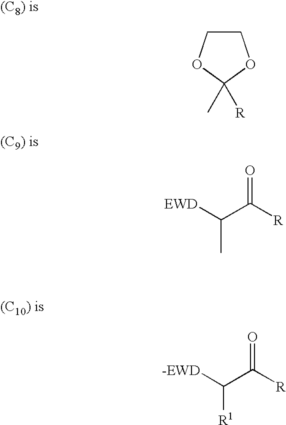
and wherein
R is a C₁ to C₁₀ alkyl or aryl group or H:
R¹ is a C₁ to C₁₀ alkyl or aryl group;
R² is a C₁ to C₁₀ alkyl or aryl group;
X is CH₂, O or NH; and
EWD is a CN, SO, SO₂, SO₃, SO₂NH, PO, PO₃ or PO₂NH group.

15. The inkjet ink set of claim 14, wherein R is a methyl group or H.

16. The inkjet ink set of claim 14, wherein the liquid vehicle of the first ink is an aqueous vehicle and the covalently bound stabilizing groups are selected from carboxylate, amine, sulfonate, sulfinate, phosphate, amine, quaternized amine, or ethoxylate oligomer groups that enable the pigment to form a stable dispersion in an aqueous vehicle.

17. The inkjet ink set of claim 14 wherein the pigment particles are selected from the group consisting of organic colored pigment particles, or inorganic pigment particles.

18. The inkjet ink set of claim 14 wherein the pigment particles are carbon black that have been oxidized to form carboxylate stabilizing groups on the surface, and which also contain covalently bound species containing at least one external reactive carbonyl group.
